(19) United States
(12) Patent Application Publication
(10) Pub. No.: US 2015/0336784 A1
(43) Pub. Date: Nov. 26, 2015

(54) WINE BLENDING SYSTEM AND METHOD

(71) Applicant: Napa Technology, Campbell, CA (US)

(72) Inventors: Nick Moezidis, San Jose, CA (US); Edward A. Vetter, Santa Clara, CA (US)

(73) Assignee: Napa Technology, Campbell, CA (US)

(21) Appl. No.: 14/715,415

(22) Filed: May 18, 2015

Related U.S. Application Data
(60) Provisional application No. 61/994,603, filed on May 16, 2014.

(51) Int. Cl. B67D 1/00; B67D 1/08; B67D 1/12

(52) U.S. Cl. CPC B67D 1/0016; B67D 1/1231; B67D 1/0888

(57) ABSTRACT

A system and method for wine blending using a wine dispensing system of the type that has a pour spout. Wine is dispensed through each of a plurality of pour spouts from a each of a plurality of component wine sources, such as bottles or kegs of wine. From each dispense head the wine flows into a hose joined to a mixing manifold. The mixed wine then flows to an air excluded container, from which it may then be bottled. A user specifies a recipe, which dictates the proportion of each component wine in a blend.

### CROSS-REFERENCE TO RELATED APPLICATION

This application claims priority under 35 U.S.C. 119(e) from prior U.S. provisional application 61/994,603, filed May 16, 2014.

### TECHNICAL FIELD

The present invention relates to a liquid dispensing system and more specifically a method and system for blending wine

### BACKGROUND ART

Wine dispensing systems provide a number of advantages for dispensing beverages such as wine, sparking wine (champagne), spirits and other beverages. These advantages include the ability to precisely pour wine and other liquids, the preservation of wine between pours, the ability to automate the serving process (saving time and making servings uniform), and an ability to track inventory through the software used to run a wine dispensing system. One such system is the Wine Station® brand wine dispensing system, distributed by Napa Technology® (Campbell, Calif.). This system is described in U.S. Pat. No. 7,712,631, which is hereby incorporated for all purposes herein.

Wine blending has become increasingly popular. Many wineries sell blends of wine, including wines from their own winery and wines taken from a variety of wineries. This allows for tailoring the blend to achieve a result that is more consistent, year after year, than if relying on simply a single varietal. For example, if one variety has an off year, the use of that variety can be reduced in favor of other varieties.

Wine blending is also increasingly offered as a service and product. This may take the form of a “blending experience” offered to wine consumers. The consumers start with a tasting, and note the flavors and characteristics of wine sampled. The user then pour amounts of wine into a container (such as a glass or beaker), noting the amount of each type of wine added to a mix. The blending process continues until the user is satisfied with the resulting blend. The winery then makes for the user one or more bottles of wine using the notes supplied by the consumer. This process in currently done by hand, which is a labor intensive and commonly messy and less precise process.

It is an object of embodiments of the invention to improve the blending process.

### SUMMARY

A wine blending system including a user input mechanism, such as the LED display and input buttons on a wine dispensing system or a separate computer having a blending interface page. The user input mechanism is configured to allow a user to specify a blend recipe including a proportion of a plurality of component blending wines. The recipe information is transferred (via hard wiring or wireless data transfer) to a wine dispensing system. The wine dispensing system includes a plurality of pour spouts each connected to one of a plurality of component wine sources. Each pour spout is connected to an associated hose. A number of hoses are joined to a mixing manifold, such that component wines transferred by said hoses mix within said mixing manifold. The mixing manifold transfers the blended wine into a vat. An air exclusion mechanism in the vat prevents air exposure of the blended wine, preserving wine quality. A spout on the vat allows blended wine to be dispensed from the vat, into bottles for example. The system can use a set of 4 or 8 spouts and hoses, or could use as few as 2 or as many as 10 or more. However blends with over 8 component wines are seen as impractical. The source wine can be from bottles or kegs. If the source of component wines is a keg, the dispense head on the wine dispensing system can be adapted for use with kegs.

### BRIEF DESCRIPTION OF THE DRAWINGS

FIG. 1 is a front view of a wine dispensing system, including an associated computer.

FIG. 2 is a front view of a wine dispensing system, a plurality of tubes connected between the dispense heads and a mixing manifold, and a fill container.

FIG. 3 is a front view a wine blending system display and associated buttons.

FIG. 4 is a display graphic.

FIG. 5 is a system diagram of a multi user blending station.

FIG. 6 is a is a front view of a system, showing two dispense heads modified to pour from kegs, and a partial cutaway showing a tube leading to a rear wall connector.

FIG. 7A is a detail from the back of a system, showing connections of four wine supply tubes to a back wall of a wine dispensing system.

FIG. 7B is a view of a wine holding keg.

FIG. 8 is a screen shot of a user interface for systems presented.

### DETAILED DESCRIPTION

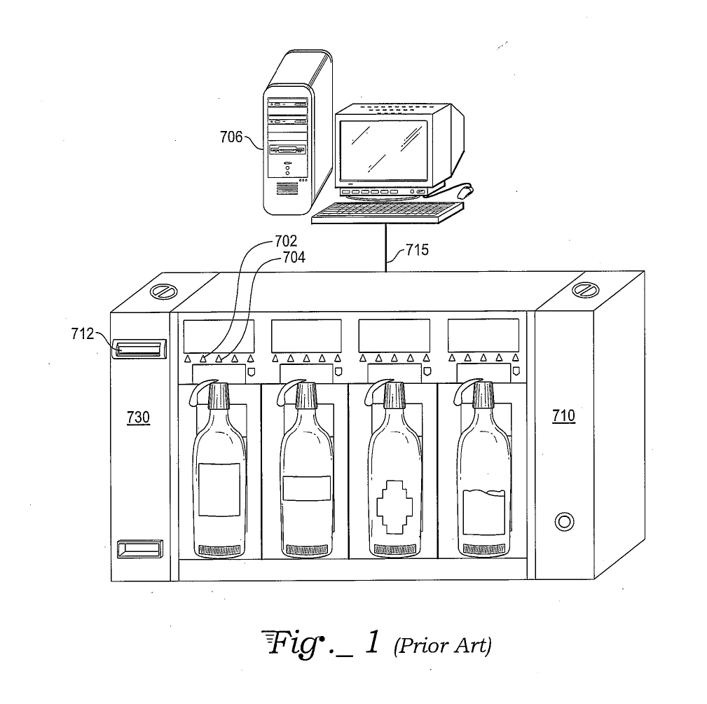

With reference to FIG. 1, a wine dispensing system 710 is shown holding four bottles of wine, each having an attached dispense head with a pour spout. A side component 730 includes a card reader 712. A user can be assigned an identification card, which could be a smart card, magnetic strip card, RFID card, etc. The card can be a hotel room key card or credit card (either of which are already associated with a specific user), or a proprietor can issue a user specific card (for a wine blending event for example). The user then selects a wine by pressing a “pour” button 702. At least one such button is associated with each of the wines poured by the system. In existing wine dispensing system, each wine has at least three buttons (which in certain commercial systems specify dispensing three different pour amounts—e.g. taste, half-glass, full-glass). These three buttons may be repurposed in a wine blending system, as shown in FIG. 3.

With reference to FIG. 3, a display allows both display of information about the wine dispersed, but also, in this embodiment, shows the percentage of this wine to be included in the blend. Buttons 52 and 56 allow the amount of this wine to be increased or decreased respectively. In this embodiment, each press of a button increments by one percent the percentage of the associated component wine. So to decrease the wine from 25% of the blend to 20% of the blend, the button on the right would be pressed five times. The display also shows a “total”. This needs to be 100% for the pour to occur. If one component wine in a blend is decreased, another component wine must be increased by a similar amount. In an alternative embodiment, the recalculation would be done automatically by a processor. If one component wine was decreased from 25% to 24

%, the system would simply calculate a ratio of:

24 parts first component wine

25 parts second component wine

25 parts third component wine; and

25 parts fourth component wine.

The system would the recalculate the percentages for this ratio with a 100% total.

Returning to FIG. 1, the system measures (using the system flow meter) the amount of wine poured and this is stored in a computer memory 706 joined to the system through a wireless connection or a via wire 715. If additional wine from the same bottle is added, this amount is added to the first amount, as the user adjusts the volumes to achieve a specific taste. When the user is satisfied with the blend, a second button 704 is pushed. The computer 706 then assigns the mixture a blend identification and stores the identification of each wine and the volume of each wine dispensed.

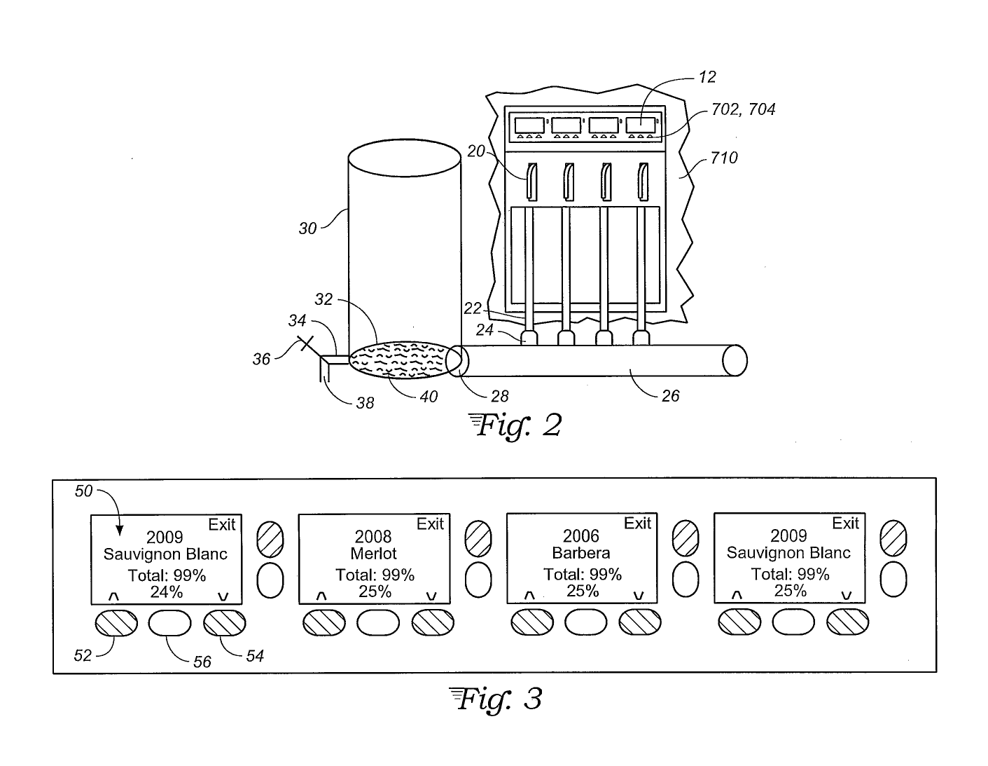

With reference to FIG. 2, a blending wine dispenser is shown. This includes a wine dispensing system 710 having a display 12. The display includes buttons 702 and 704. This display is described in greater detail above with respect to FIG. 3.

The dispensing system includes a plurality of pour spouts 20. Each pour spout is connected by a hose 22 to a mixing manifold 26 by a hose coupler 24. Hose coupler 24 simply provides a convenient method of attaching the,hose 22 to the mixing manifold 26. The mixing manifold is attached to a vat 30 by a manifold coupler 28. Within vat 30 an air exclusion bladder 32 prevents wine 40 from mixing with air. Bladder 32 lifts and expands as the bladder fills with wine. The wine may then be dispensed from tap pipe 34 through pour spout 38 regulated by valve 36.

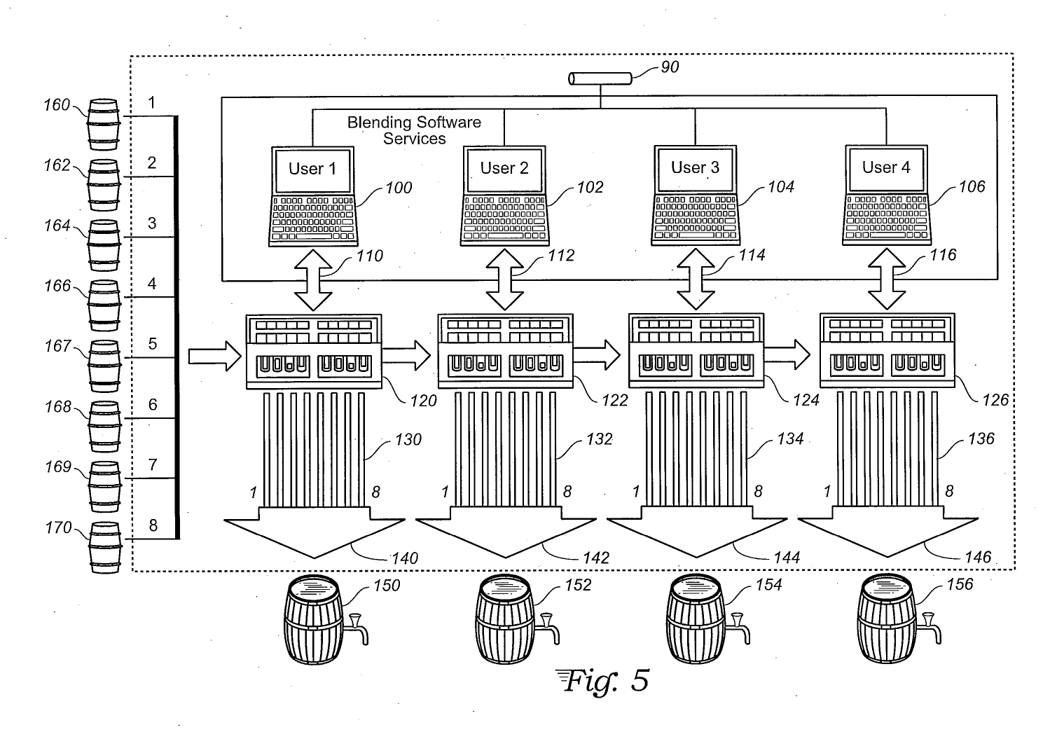

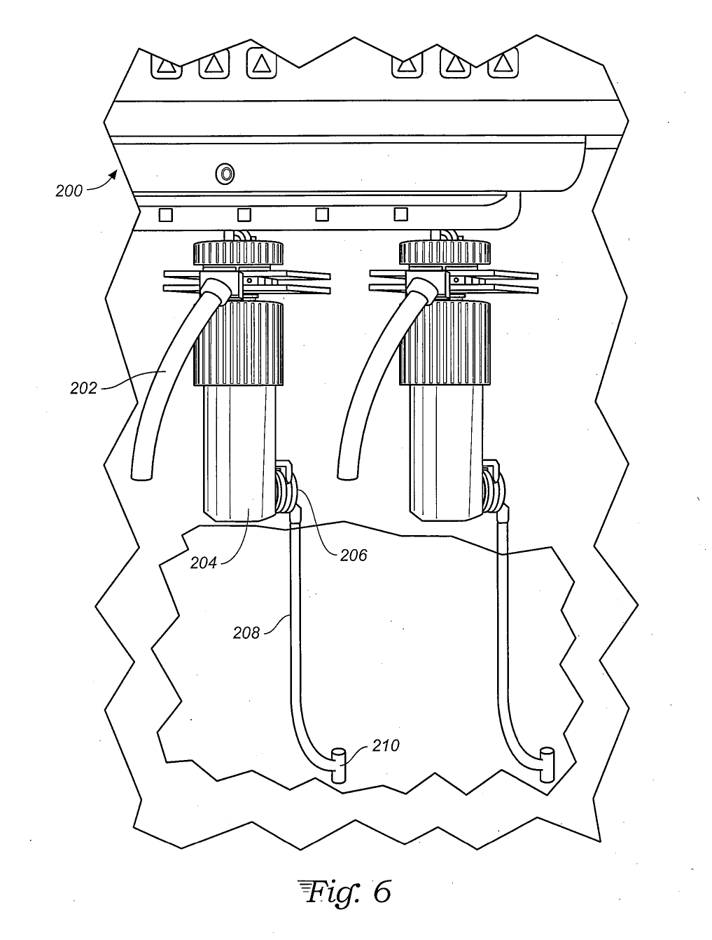

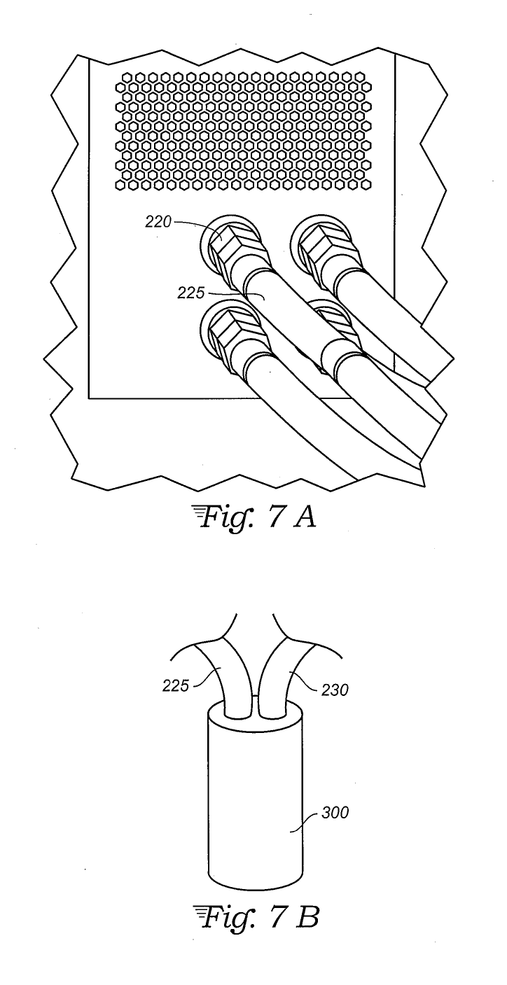

The illustrated embodiment of FIGS. 1 and 5, the illustrated systems blend from bottles. In an alternative embodiment, the source of wine for each component wine in a blend is from a keg. 5 gallon kegs of wine are increasingly available from a number of different sources. Bottles are quite heavy, kegs are a much more efficient way to transport and store liquid. For wine blending, the use of source kegs is preferred. An adapter for a dispense head, used on a dispensing machine is shown in FIG. 6. The wine dispensing system 200 has mounted on it a plurality of dispense heads having pour spouts 202. The hoses of FIG. 2 would be attached to spouts 202. In the prior system dispense head, the dispense head would include a stopper, which would be inserted into a bottle of wine. This stopper is removed and instead the dispense head has a keg adapter 204 which is joined to tube coupler 206. Tube coupler 206 secures internal tube 208 which terminates at interior rear wall coupler 210. FIG. 7A shows the rear exterior of a dispense system. Four input component wines are introduced into the dispense system using exterior transfer tubing. Exterior rear wall coupler 220 couples to exterior transfer tube 225. With reference to FIG. 7B, a source keg 300 contains a component wine. The wine is dispensed from this keg into tube 225 through a interior keg tube (not shown). A gas tube 230 provides a means of introducing gas into the keg, thereby displacing a selected volume of wine. The gas is regulated and controlled by the wine dispenser, as described in detail in U.S. Pat. No. 7,712,631, hereby expressly incorporated by reference for all purposes herein.

As shown in FIG. 5, the system is highly scalable. The number of source wine, user computers, wines to be blended is exemplary, and different numbers of various component elements are contemplated. The minimum number of wines to be blended is two, and the maximum is not limited, although blending more than 8 wines is a practical upper limit. More than 8 are possible, but the user experience is believe best when 8 or fewer wines are tasted and blended. So the source wines can be from 2-8, as selected by a user.

With respect to FIG. 5, the blending station configuration shown includes a number of computers 100, 102, 104, 106. Each of the computers is linked to a central database, 90. User information stored in the database is available to each computer. Each of the computers is connected by an associate connection 110, 112, 114, 116 to a respective wine dispensing system 120, 122, 124, 126. Each of the wine dispensing system can draw from component wine kegs 160, 162, 164, 166, 167, 168, 169, 170. These component wine kegs are joined by tubing to a plurality of wine dispensing systems. The wine flows from each of the wine dispensing systems flows into hose array 130, 132, 134, 136 respectively. Each hose array terminates in a mixing manifold 140, 142, 144, and 146. It should be understood that this may be all 8 hoses joined to a single manifold, or two mixing manifolds used, one for the first four hoses, the second for the second four hoses. The mixing manifolds each flow into respective vats 150, 152, 154 and 156.

The use of the Wine Station® brand wine dispensing system for blending allow use of a readily available system, a system commercially in use, and known to be reliable. Each Wine Station® brand wine dispensing system can dispense 4 types of wine, so it is envisioned that the blending station support blending of at least 4 types of wine.

In some embodiments, such as that pictured in FIG. 5, the wine blending may use different users at different terminals, such as a laptop. These may be connected together in a network, or otherwise all connected to a centralized database. Thus recipes and customer information is centralized. This customer information can be saved by entry into the laptop or entry by the winery or other user into the database directly. Thus no smart card associated with a user is required in this embodiment. For each customer the system by store multiple named blends. The customer information can be searchable in a number of different ways, including (but not limited to):
Phone Number
First Name
Last Name
Email address

Once customer information is found, the system can display the blends associated with that customer.

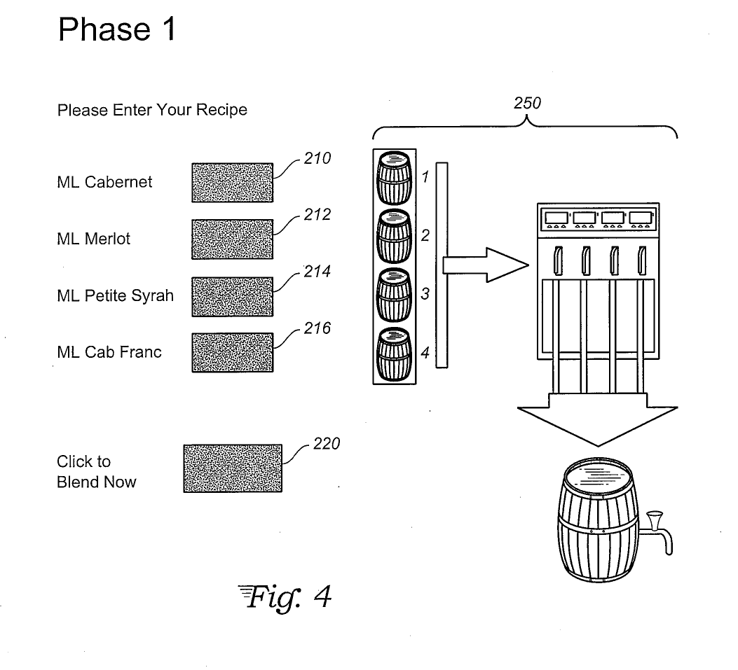

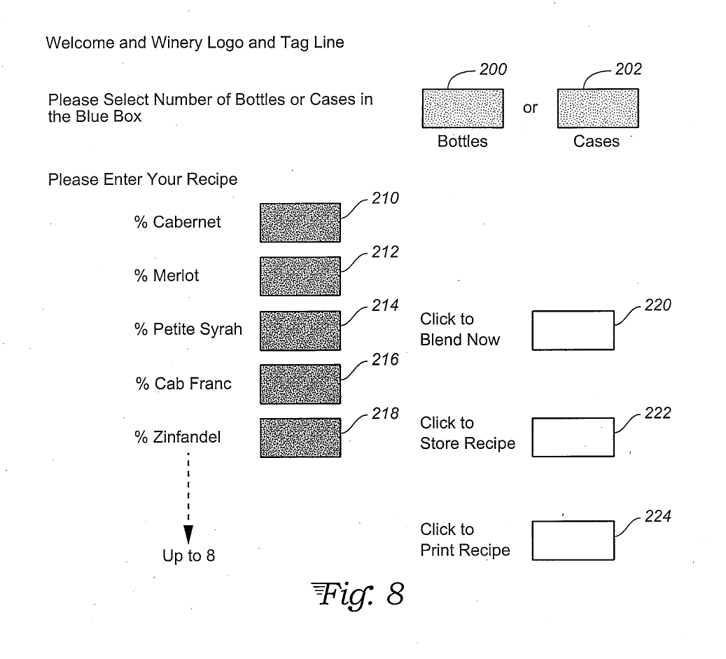

With respect to FIGS. 4 and 8, these are screen shots to be displayed to a user. As shown in FIG. 8, the initial Wine Blending Screen would request the quantity desired as either a selected number of bottles (space 200) or a selected number of cases (12 bottles/case).

For the Wine Station, databases, such as that of wine information already exists. Wine information would be in existing database tables. In addition, location information would be in existing database tables. In addition, customer information for existing customers would be in existing database tables.

FIG. 4 and FIG. 8 illustrate screen shots of a wine dispensing system management console. Such a management console would provide a window to control blending on the wine dispensing system without having to press buttons on the dispensing system LCD panel shown in FIG. 3. This functionality would require new commands and responses with the dispense system firmware. As shown in FIGS. 4 and 8, the screen has percentages for component wines, entered in blocks 210, 212, 214, 216, 218. When complete the user hits button 220 (blend now).

The dispense system will automatically blend. The screen can also have a button to store the recipe (button 222) or print the recipe (button 224).

In one embodiment all of the pouring activity during blending would be logged to a database table.

Those of skill in the art will understand that the embodiments described herein provide the foundation for numerous alternatives and modifications. As noted, the wine sources can be bottles or kegs, the number of components, such as pour spouts and associated hoses can vary. Certain illustrated embodiments are adapted from the Wine Station® brand wine dispensing system. Other systems are possible. The system is described in respect to wine blending, but there is no reason why spirits or other liquids cannot be blended by this system and method. These and other modifications are also within the scope of the present invention, and the invention is not limited to the described embodiments, which are illustrative.

What is claimed is:

1. A wine blending system comprising:
a user input mechanism configured to allow a user to specify a blend recipe including a proportion of a plurality of component blending wines;
a link for transfer of recipe information to a wine dispensing system, said wine dispensing system including a plurality of pour spouts each connected to one of a plurality of component wine sources;
a plurality of hoses, wherein each hose of said plurality of hoses is attached to one pour spout of said plurality of pour spouts;
a mixing manifold, wherein a plurality of said hoses is joined to said mixing manifold such that component wines transferred by said hoses mix within said mixing manifold;
a vat joined to said mixing manifold such that wine blended by said mixing manifold is received in said vat, said vat including an air exclusion member configured to prevent air from mixing with blended wine; and
a spout on said vat allowing blended wine to be poured from said vat.

2. The wine blending system of claim 1, wherein the number of spouts in said plurality of spouts, and number of hoses in said plurality of hoses is 4.

3. The wine blending system of claim 1, wherein the number of spouts in said plurality of spouts, and number of hoses in said plurality of hoses is 8.

4. The wine blending system of claim 1, wherein said dispense spouts are on a dispense head having a keg adapting member, allowing a keg of wine to act as the source for component wines.

5. The wine blending system of claim 1, wherein said user input mechanism is a set of buttons and associated display screen on said wine dispensing system.

6. The wine blending system of claim 1, wherein said user input mechanism is a computer which is separate from said wine dispenser and is connected electronically to said wine dispenser, allowing dispense instructions to be transferred to said wine dispenser.

7. A method of blending wine, comprising:
entering a recipe into an electronic memory, said recipe specifying component wine amounts;
dispensing from a wine dispensing system said component amounts in a volume consistent with a selected final volume; wherein said wine from each of a plurality of sources is each dispensed through a unique dispense spout, through a hose and into a mixing manifold, said mixing manifold receiving wine from a plurality of dispense spouts; and
filling an air excluding container with mixed wine from said dispense manifold.
